(19) United States
(12) Patent Application Publication
(10) Pub. No.: US 2019/0066426 A1
(43) Pub. Date: Feb. 28, 2019

(54) PERFORMANCE ATTENDEE VOTING ARCHITECTURE, SYSTEM AND METHOD

(71) Applicant: Panza Technologies, Inc., New York, NY (US)

(72) Inventors: David Ryan Reed Keene, San Diego, CA (US); David Edward Carpenter, Peekskill, NY (US); Edward Michael Cox, San Diego, CA (US); John Arthur Pinckard, New York City, NY (US)

(73) Assignee: Panza Technologies, Inc., New York, NY (US)

(21) Appl. No.: 16/112,247

(22) Filed: Aug. 24, 2018

Related U.S. Application Data
(60) Provisional application No. 62/550,555, filed on Aug. 25, 2017.

(51) Int. Cl. G07C 13/00; G06F 17/30

(52) U.S. Cl. CPC G07C 13/00; G06Q 2230/00; G06F 17/30896

(57) ABSTRACT

Embodiments enabling performance attendees to participate in performances via a provided or personal device. Other embodiments may be described and claimed.

### TECHNICAL FIELD

Various embodiments described herein relate generally to enable performance attendees to participate in performances.

### BACKGROUND INFORMATION

It may be desirable to enable performance attendees to participate in performances via a personal or provided device, the present invention enables such participation.

### BRIEF DESCRIPTION OF THE DRAWINGS

FIG. 1A is a block diagram of multiple performance attendee participation architecture (MPAP) according to various embodiments.

FIG. 1B is a block diagram of another multiple performance attendee participation architecture (MPAP) according to various embodiments.

FIG. 1C is a block diagram of a local or single performance attendee participation architecture (SPAP) according to various embodiments.

FIG. 1D is a block diagram of another multiple performance attendee participation architecture (MPAP) according to various embodiments.

FIG. 2A is a diagram of communications between devices and systems in single or multiple performance attendee participation architecture according to various embodiments.

FIG. 2B is a diagram of communications between devices and systems in single or multiple performance attendee participation architecture according to various embodiments.

FIG. 3A is a block diagram of single or multiple performance attendee participation architecture providing a user or attendee performance registration page to a user device according to various embodiments.

FIG. 3B is a block diagram of single or multiple performance attendee participation architecture providing a user or attendee performance vote page to a user device according to various embodiments.

FIG. 3C is a block diagram of single or multiple performance attendee participation architecture providing a user or attendee performance vote page with tallies to a user device according to various embodiments.

FIG. 3D is a block diagram of single or multiple performance attendee participation architecture providing an activity control system (ACS) vote control page to an ACS according to various embodiments.

FIG. 3E is a block diagram of single or multiple performance attendee participation architecture providing a tech system production page to a tech system according to various embodiments.

FIG. 4 is a block diagram of a central vote system (CVS) according to various embodiments.

FIG. 5A is a flow diagram illustrating several methods according to various embodiments.

FIG. 5B is a flow diagram illustrating several methods according to various embodiments.

FIG. 5C is a flow diagram illustrating several methods according to various embodiments.

FIG. 5D is a flow diagram illustrating several methods according to various embodiments.

FIG. 6A is a block diagram of an article according to various embodiments.

FIG. 6B is a block diagram of an article according to various embodiments.

### DETAILED DESCRIPTION

Attendees of a performance may be given the opportunity to participate including voting for an event(s)/activities to occur in the performance. The performance could be a live or pre-recorded event including, theater, movie, or sports performance, e.g., an Attendee may vote for the next play to be submitted in a soccer match or the fate of character(s) in a play or movie. For a movie, based on the Attendee(s) vote/elections, different tracks may be played. For a live performance, the actor(s) may follow or create different scripts based on the Attendee(s) vote/elections. An attendee may be given the option to vote or elect on an event, play, action, character, lighting, sound, or other performance characteristic via an electronic device. The electronic device may be a portable electronic device provided to the Attendee or the Attendee's own electronic device (ED). Votes or elections may be communicated via an Attendee's ED wirelessly including via AD HOC, peer to peer, cellular, local WiFi, or other wireless communication platforms.

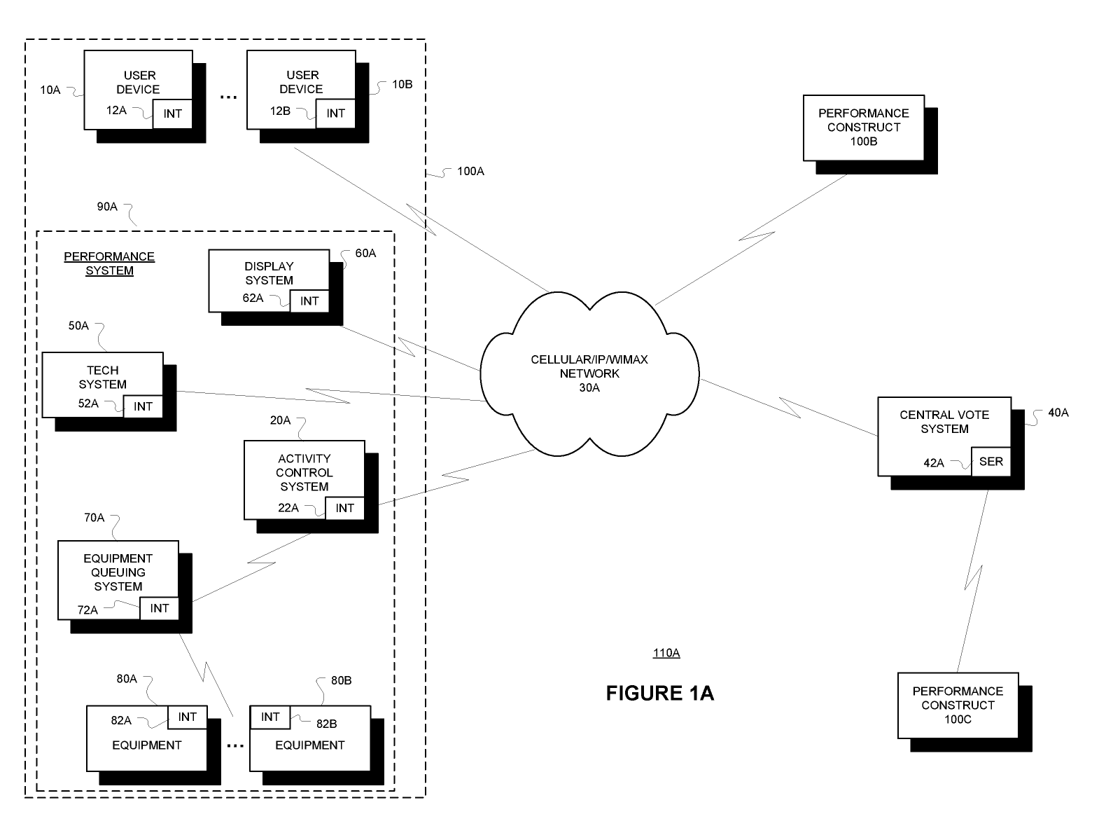

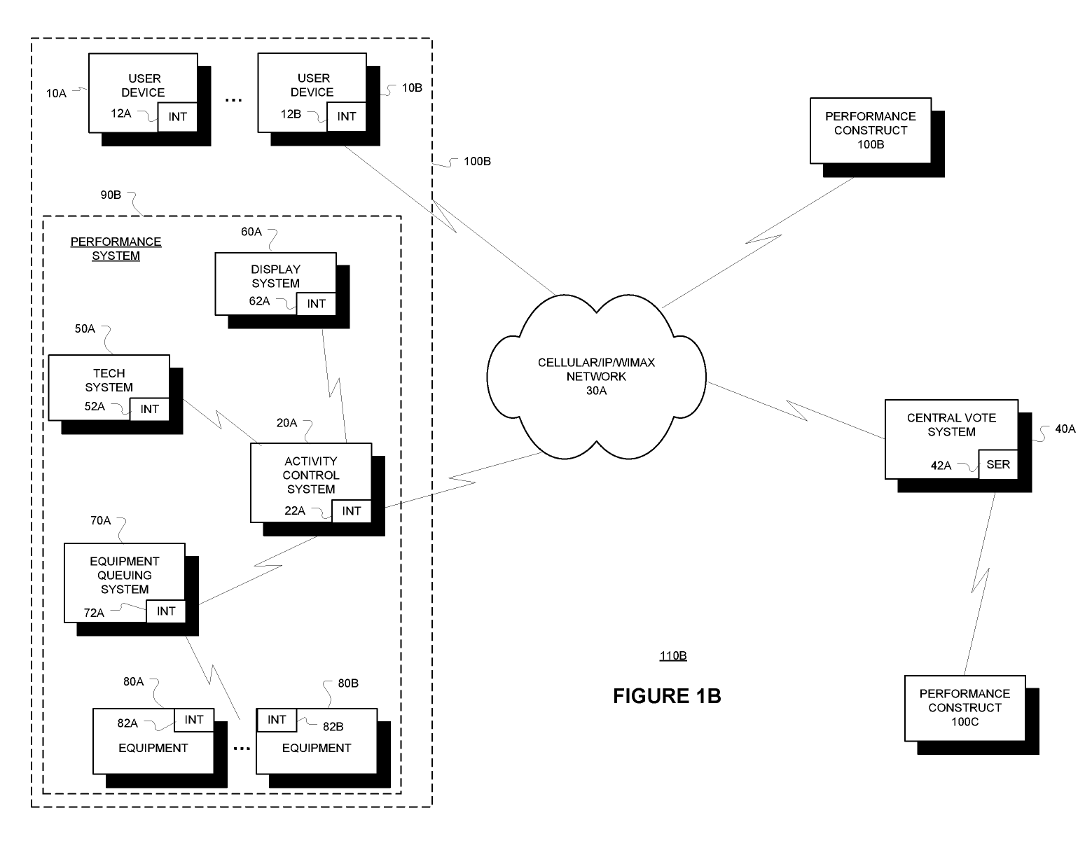

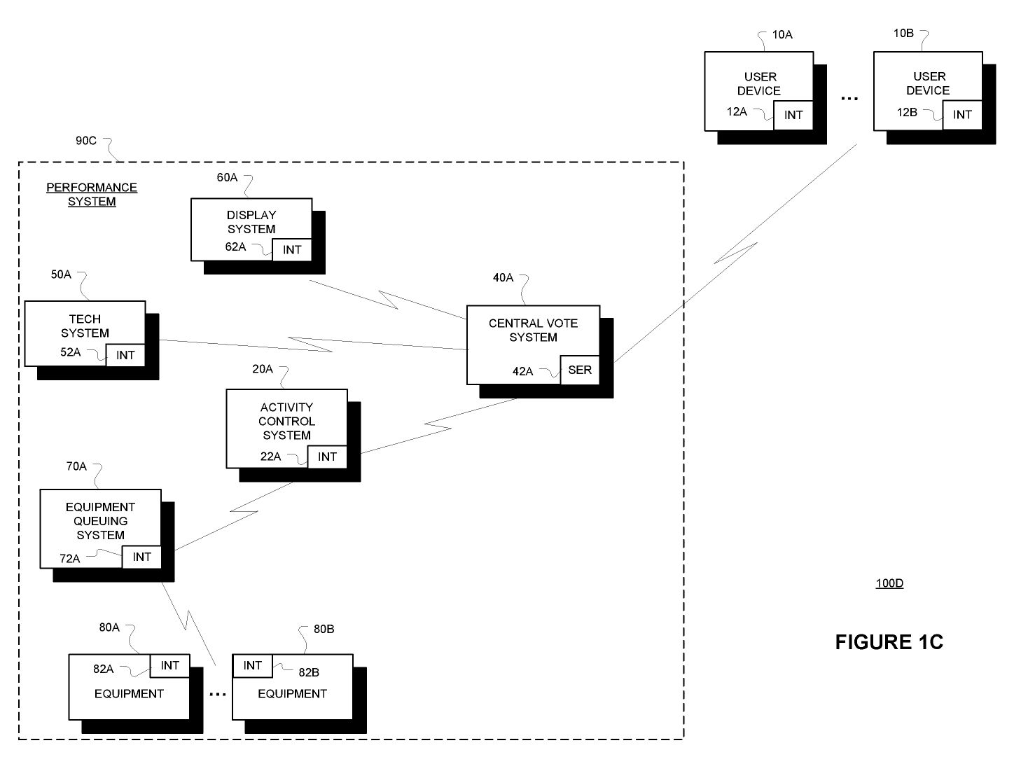

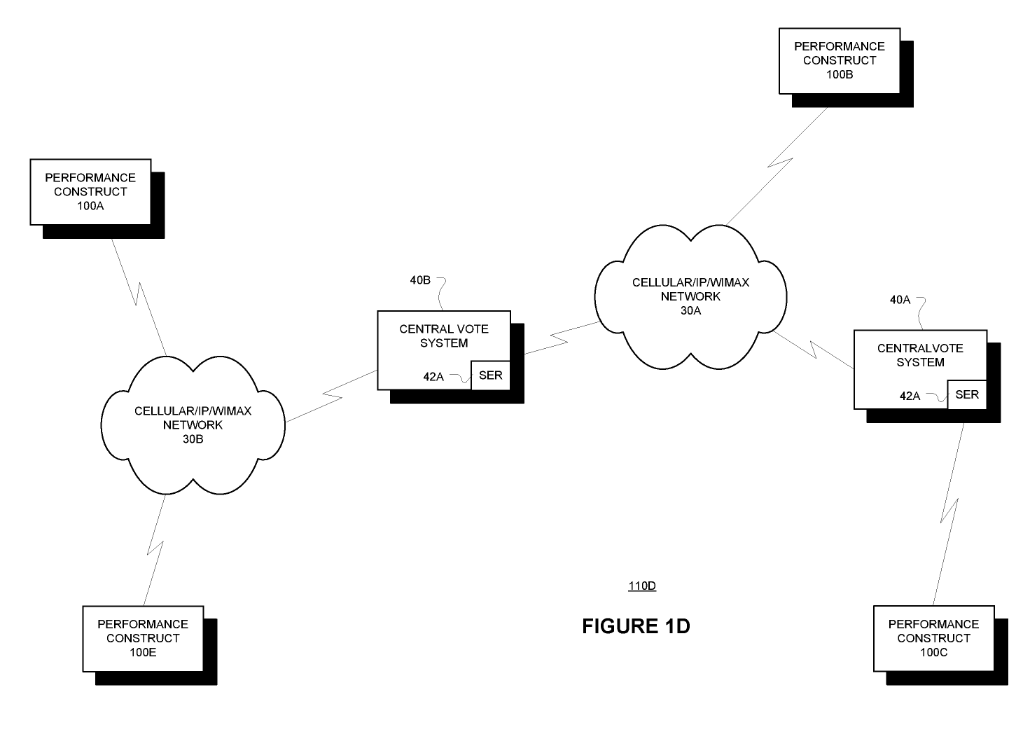

FIG. 1A is a block diagram of multiple performance attendee participation architecture (MPAP) 110A according to various embodiments. As shown in FIG. 1A, multiple performance attendee participation architecture (MPAP) 110A may include a central vote system (CVS) 40A coupled to several performance attendee participation constructs (PAPC) 100A, 100B, 100C, directly (100C) or indirectly (100A and 100B) via a network 30A. As also shown in FIG. 1A, a performance attendee participation construct (PAPC) 100A may include a performance system 90A and one or more attendee or user devices 10A-10B. In an embodiment, a PAPC 100A-C may be located at or near a performance where an attendee may participate via a voting process.

As further shown in FIG. 1A, a performance system 90A of a performance attendee participation construct (PAPC) 100A may include several components, elements, or systems, including an activity control system 20A, a technician or tech system 50A, a performance display system 60A, and an equipment queuing system 70A coupled to performance equipment 80A-80B. In order to enable one or more attendee(s) 136 of a performance to affect the performance in some way (participate), an attendee 136 may be invited to “vote” on some attribute of the performance. For example, an attendee may vote where a character may go, whom a character may meet, marry, murder . . . during the performance of a live theater production or other event.

There may be a single vote for a performance or many possible voting opportunities during a performance. Further, the vote options may change during the performance based on the past votes. Accordingly, each performance may be unique based on the votes of the attendees in an embodiment. Due to the variable nature of certain performances including sporting events where penalties, scores, injuries change in real time, the voting options, start of a vote, and ending of a vote may need to be controlled by a manager at or monitoring the performance. Further, the vote decision may affect the timing of the next vote if any, requiring personal intersession to manage the performance and future votes.

In an embodiment, a stage manager or other event manager may employ the activity control system 20A of a performance system 90A to start a voting event and end a voting event. As explained in more detail, an attendee via a user device 10A, 10B may be linked or registered to participate in a performance via communications with a CVS 40A. The CVS 40A may enable attendees to vote on a performance activity or event and see vote tallies for their performance or other related performances once the activity control system 20A via a manager starts a vote. Similarly, a CVS 40A may stop attendees from voting on a performance activity or event and see final vote tallies for their performance or other related performances once the activity control system 20A via a manager ends a vote for an activity.

In an embodiment via the CVS 40A, attendees via their user devices 10A-B may be able to vote simultaneously. The CVS 40A may tally votes and provide the results in real time or at end of vote to the display system 60A, tech system 50A, user devices 10A-B, and activity control system 20A. In an embodiment, the display system 60A may include a visual projector whose output is visually available to the attendees. The display system may show the vote options available to the attendees, progress of the vote (tallies), results of votes at other performances at the same location or different locations, and results. The CVS 40A may forward vote options and vote tallies to the display system 60A once the activity control system 20A via a manager starts a vote. Similarly, a CVS 40A may forward final vote tallies for their performance or other related performances to the display system 60A once the activity control system 20A via a manager ends a vote.

Depending on a number of factors including number of performance participants, stage complexities, lighting, sound, and other performance variables, one or more technician systems 50A may be placed about the performance area, such as back stage, in actor rooms, below stage, above stage, and other areas, where the tech systems 50A may show vote options, tallies, and results so the performance participants and crew may anticipate, plan, and stage or modify performance attributes or events based on the vote(s). In an embodiment, the tech system 50A, display system 60A, and activity control system 20A may include or employ electronic devices including portable computers such as laptops, tablets, and mobile telephones. In an embodiment, the CVS 40A may forward vote options and vote tallies to tech systems 50A once the activity control system 20A via a manager starts a vote. Similarly, a CVS 40A may forward final vote tallies for their performance to tech systems 50A once the activity control system 20A via a manager ends a vote.

In some performances, some environmental attributes may be automatically controlled via performance equipment 80A to 80B. The controllable performance equipment 80A to 80B may control sound, lighting, scenes (movable scenes), props, smoke machines, wind machines and other controllable environmental equipment. The activity control system 20A via an equipment queuing system 70A may control the operation of one or more environment equipment 80A to 80B based on vote(s). The equipment queuing system 70A may employ a special or specific interface to control the equipment 80A to 80B including a musical instrument digital interface (MIDI). In an embodiment, the activity control system 20A may directly control the operation of one or more environment equipment 80A to 80B based on vote(s).

As shown in FIG. 1A, the systems 20A, 50A, 60A, 70A, and 80A may include interfaces 22A, 52A, 62A, 72A, and 82A that enable the systems to communicate data via wired or wireless protocols. It is also noted that in an embodiment the display system 60A may be combined with the activity control system 20A depending on the production. Similarly, the tech systems 50A may be combined with the activity control system 20A depending on the production. Additionally, the equipment queuing system 70A may also be combined with the activity control system 20A depending on the production. Finally, as shown in FIG. 1C, the CVA 40A may be combined with the activity control system 20A depending on the production. It is also noted that one or more elements of a performance system 90A may be located near or about the location where the attendees view the performance or where the performance is conducted. It is noted that in an embodiment, one or more users or attendees may remotely view a performance.

In an embodiment, the activity control system 20A, technician or tech system 50A, and performance display system 60A may communicate directly (construct 100C) or indirectly (constructs 100A, 100B) with a central vote system 40A via one or more networks 30A as shown in FIG. 1A. Similarly, attendee or user devices 10A, 10B of a PAPC 100A-C may communicate directly (construct 100C) or indirectly (constructs 100A, 100B) with a central vote system 40A via one or more networks 30A as shown in FIG. 1A. The performance system 90A equipment queuing system 70A may communicate directly (via wired or wireless connection) with the activity control system 20A as shown in FIG. 1A.

In another embodiment of a MPAP 110B shown in FIG. 1B, only the activity control system 20A may communicate directly (construct 100C) or indirectly (constructs 100A, 100B) with a central vote system 40A via one or more networks 30A. The technician or tech system 50A, performance display system 60A, and equipment queuing system 70A may communicate directly (via wired or wireless connection) with the activity control system 20A as shown in FIG. 1B. The attendee or user devices 10A, 10B of a PAPC 100A-C, however may communicate directly (construct 100C) or indirectly (constructs 100A, 100B) with a central vote system 40A via one or more networks 30A as shown in FIG. 1B.

In another embodiment, a central vote system 40A may be part of the performance system 90C such in the PAPC 100D show in FIG. 1C. As shown in FIG. 1C, the activity control system 20A, technician or tech system 50A, and performance display system 60A may communicate directly (construct 100C) or indirectly (constructs 100A, 100B) with a central vote system 40A via a wired or wireless connection. Similarly, attendee or user devices 10A, 10B of a PAPC may communicate directly (construct 100C) or indirectly (constructs 100A, 100B) via a wired or wireless connection. In PAPC 100D, the equipment queuing system 70A may communicate directly (via wired or wireless connection) with the activity control system 20A as shown in FIG. 1C.

In an embodiment shown in FIG. 1D, a MPAP 100D may include multiple central vote systems 40A, 40B. The central vote systems 40A, 40B may be coupled via a network or networks 30A and provide redundancy, backup, and faster access for PAPC 100A, 100B, 100C, and 100E as a function of their location and associated networks 30A, 30B. As shown in FIG. 1D, a PAPC 100C may be directly coupled to a central vote system 40A while other PAPCs 100A, 100B, 100E may be indirectly coupled to a CVS 40A, 40B via a network 30A, 30B and another CVS 40B, 40A (in an embodiment).

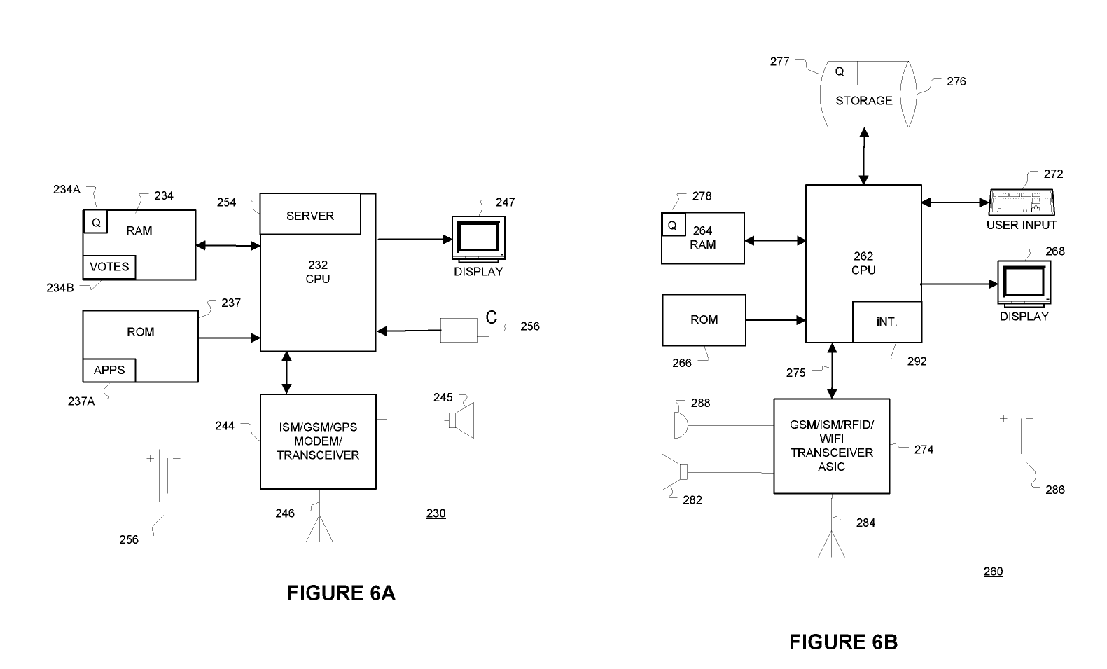

In an embodiment, a network 30A, 30B may be a local network or a network of networks. A UD 10A-B and systems 20A, 50A, 60A, 70A, and 80A may include interfaces 12A, 12B, 22A, 52A, 62A, 72A, and 82A that may include an interface (network interface controller (NIC)) that enables IP based communication with a CVA 40A or other systems 20A, 50A, 60A, 70A, and 80A. The interface 12A, 12B, 22A, 52A, 62A, 72A, and 82A may include a modem/transceiver 274 (244, FIG. 6B). The modem/transceiver 274 may include an application specific integrated circuit (ASIC). The network 30A, 30B may be a local network, a network of networks, or a worldwide network of networks, termed the “Internet”, cellular network, or WiMax networks. In an embodiment, a UD 10A-B and systems 20A, 50A, 60A, 70A, and 80A may communicate with a CVA 40A or other systems 20A, 50A, 60A, 70A, and 80A via several networks. It is noted that in an embodiment, the networks 30A, 30B may be industrial, scientific and medical (ISM) radio bands, Groupe Spécial Mobile (GSM), Code-division multiple access (CDMA), time division multiple access (TDMA), mesh, and short messaging system (SMS) based network, WiMax, IP (wired or wireless network) such as 802.11a, b, g, n networks.

In an embodiment, a UD 10A-B and systems 20A, 50A, 60A, 70A, and 80A may be a cellular device such an iPhone® or other smartphone, tablet device including an iPad®, laptop, tablet, desktop, or other electronic device capable of communicating via one or more wired or wireless protocols. In an embodiment, a CVA 40A, 40B may be an electronic device 240 that may include a module 244 to communicate signals with a UD 10A-B and systems 20A, 50A, 60A, 70A, and 80A may also include a server 42A, 42B (254, FIG. 6A).

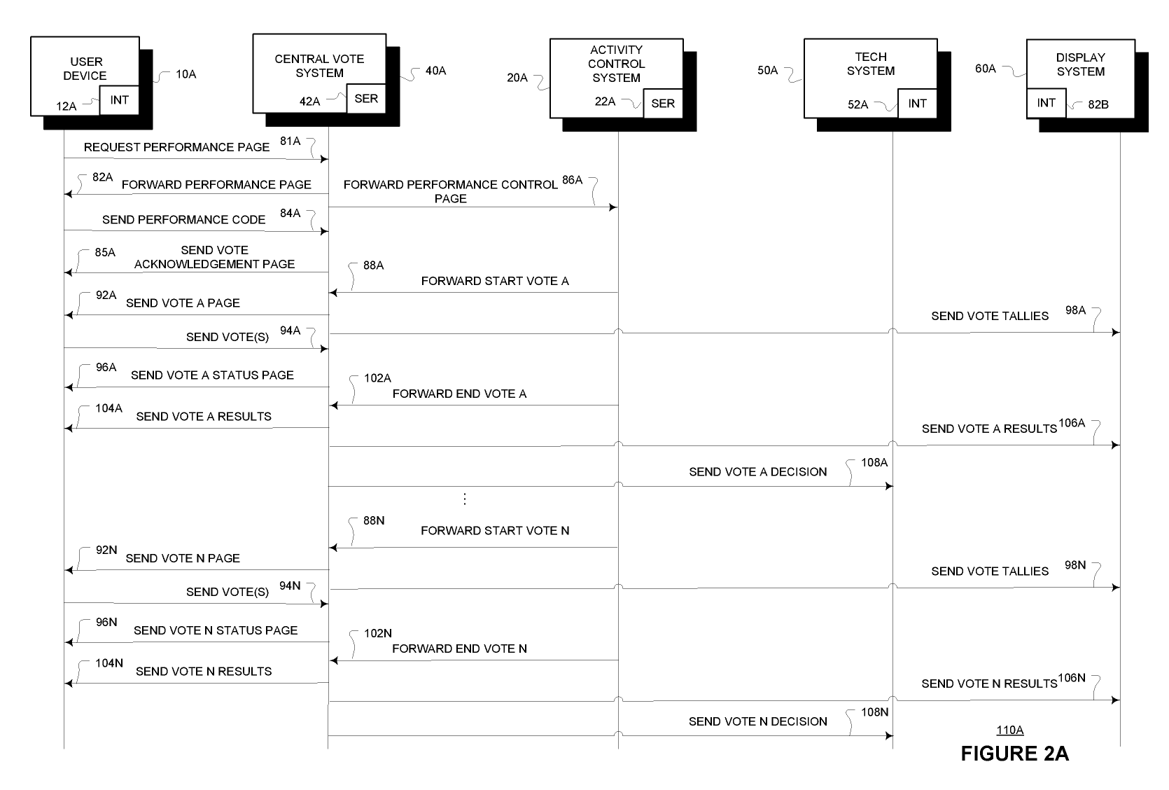

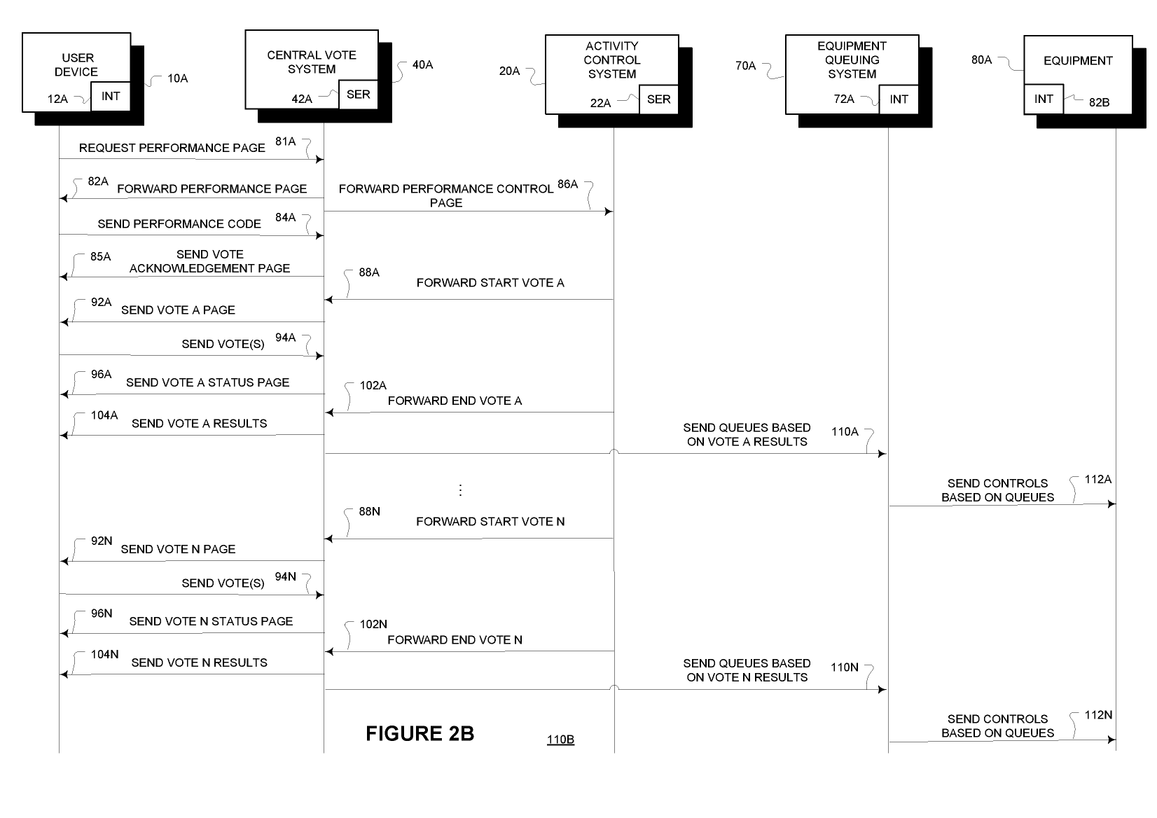

FIG. 2A is a diagram of communications between a CVA 40A, a user device 10A, an activity control system 20A, a tech system 50A, and a display system 60A in a single or multiple performance attendee participation architecture 110A-D according to various embodiments. FIG. 2B is a diagram of similar communications between a CVA 40A, a user device 10A, an activity control system 20A, an equipment queuing system 70A, and production equipment 80A in a single or multiple performance attendee participation architecture 110A-D according to various embodiments. In an embodiment and shown in FIGS. 2A and 2B, the CVA 40A controls most communications related to attendee performance participation based on the activity control system vote controls.

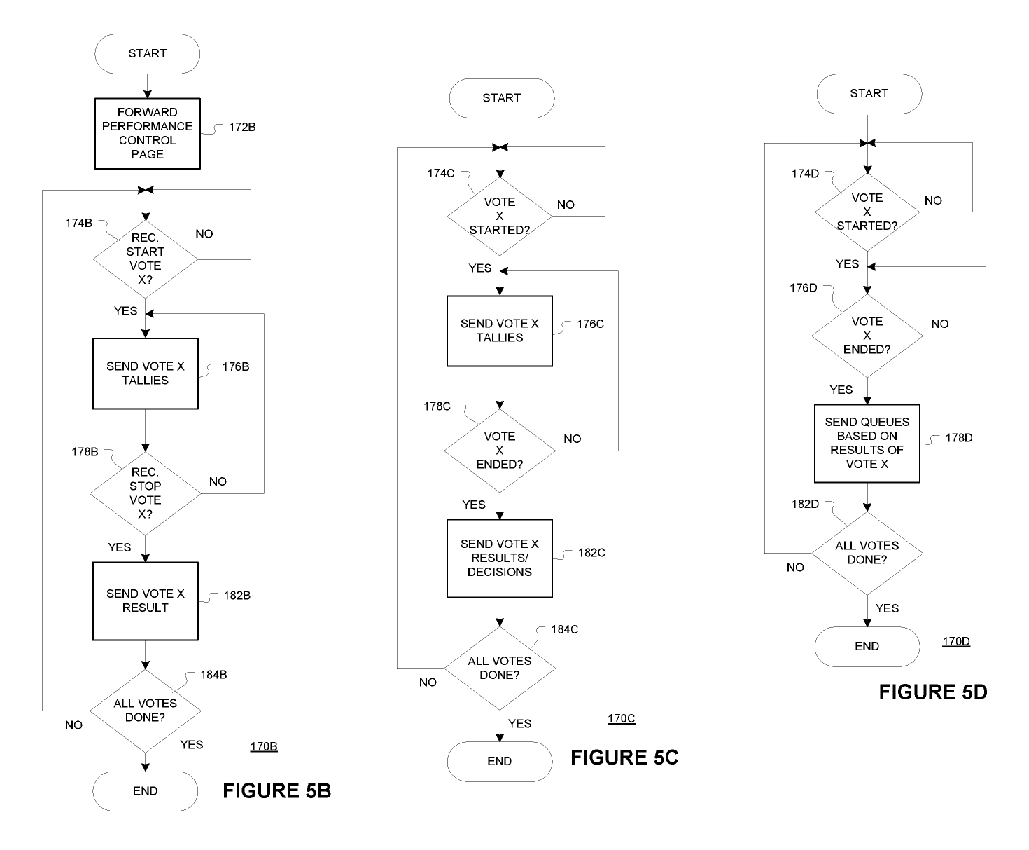

In an embodiment, FIG. 5A is a flow diagram illustrating several methods a CVA 40A may employ to communicate with User devices 10A-B according to various embodiments. FIG. 5B is a flow diagram illustrating several methods a CVA 40A may employ to communicate with an ACS 20A according to various embodiments. FIG. 5C is a flow diagram illustrating several methods a CVA 40A may employ to communicate with tech systems 50A and performance display systems 60A according to various embodiments. FIG. 5D is a flow diagram illustrating several methods a CVA 40A may employ to communicate with an equipment queuing system 70 according to various embodiments.

As shown in FIG. 2A, in an embodiment, an Attendee 136 via a User device 10A may request a performance page from a CVA 40A (communication 81A). In an embodiment, an Attendee may be directed to a web page to participate in a performance where the web page is a performance page. The web page URL may be provided to the Attendee at the performance, printed on an admission ticket, provided on a playbill, displayed on a screen, or communicated electronically to the Attendee's UD 10A-B. In an embodiment, the URL may be provided once an Attendee logs onto a particular WiFi SSID broadcast at the performance. In an embodiment, the performance system 90 may include a WiFi router than provides wireless access. In another embodiment, an Attendee may download or have downloaded a performance participation application that communicates with the CVA 40A to receive a performance page.

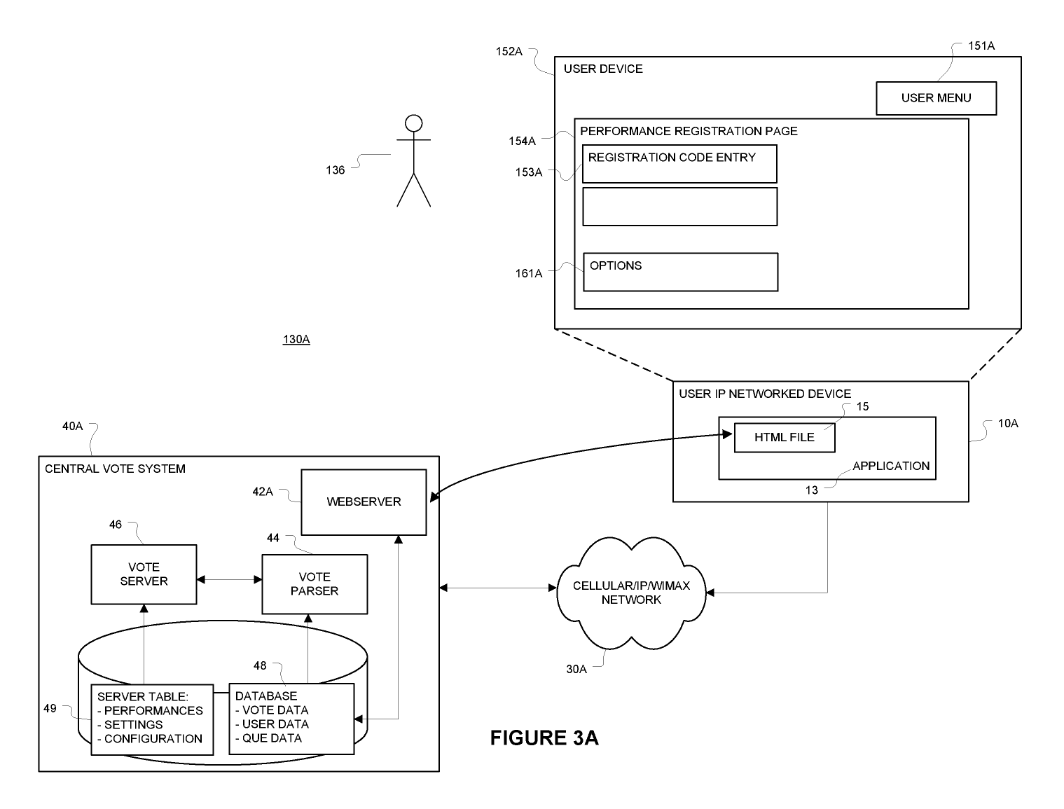

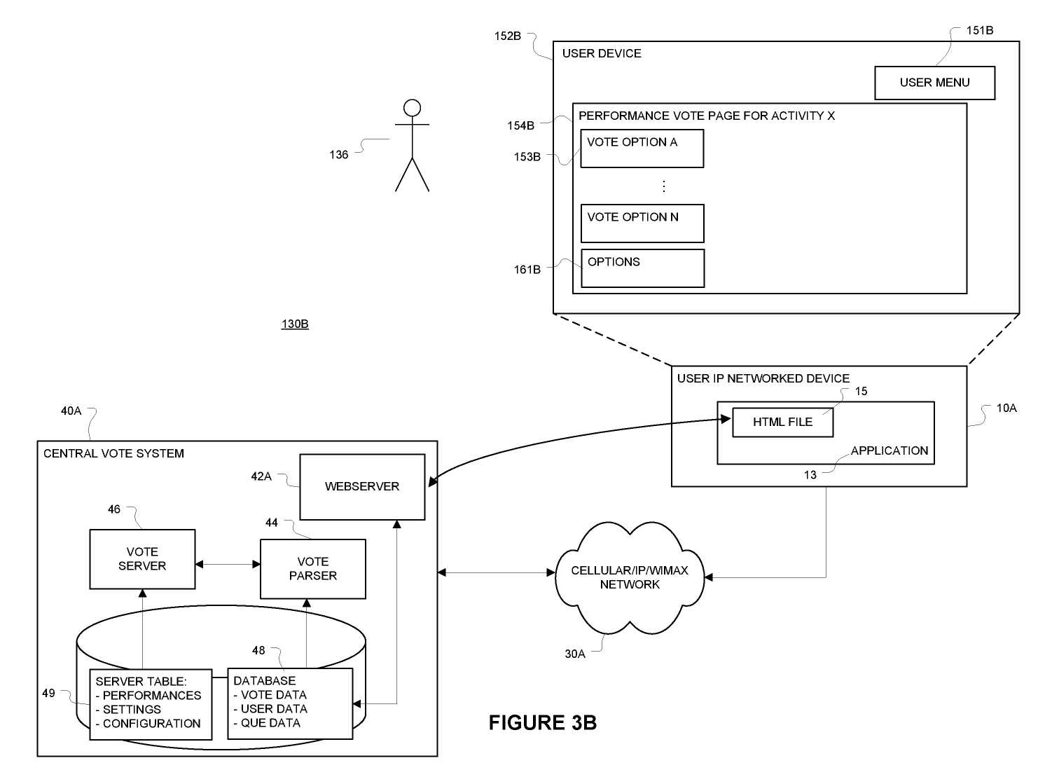

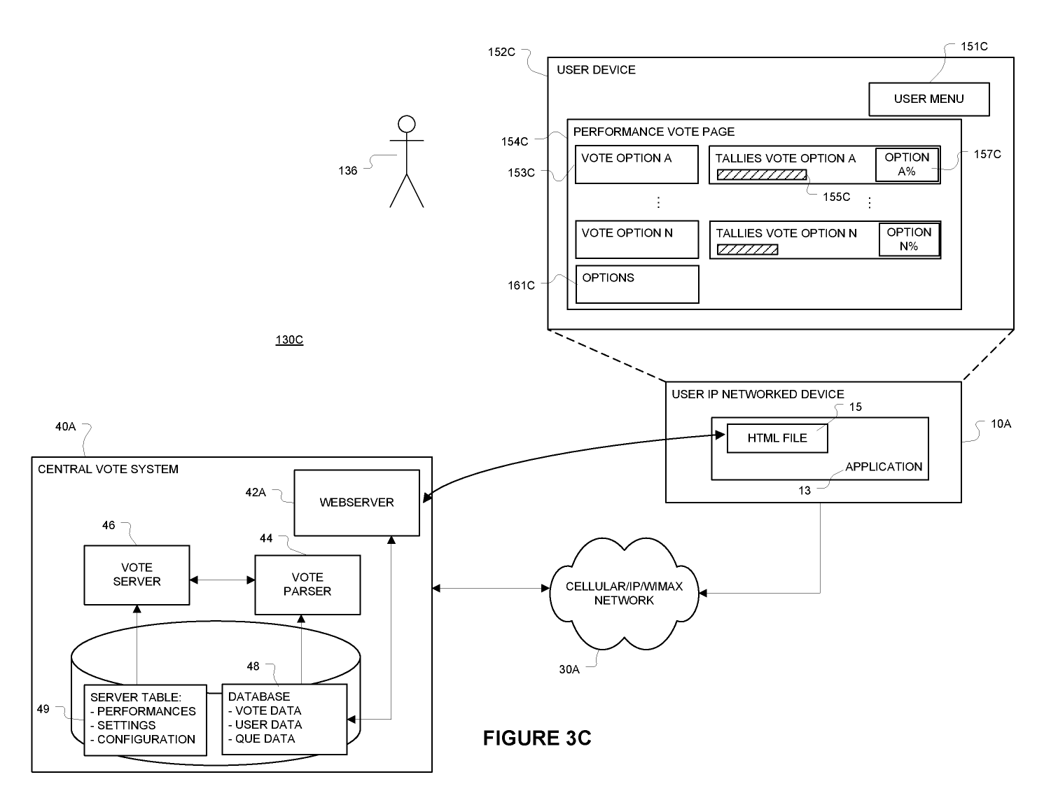

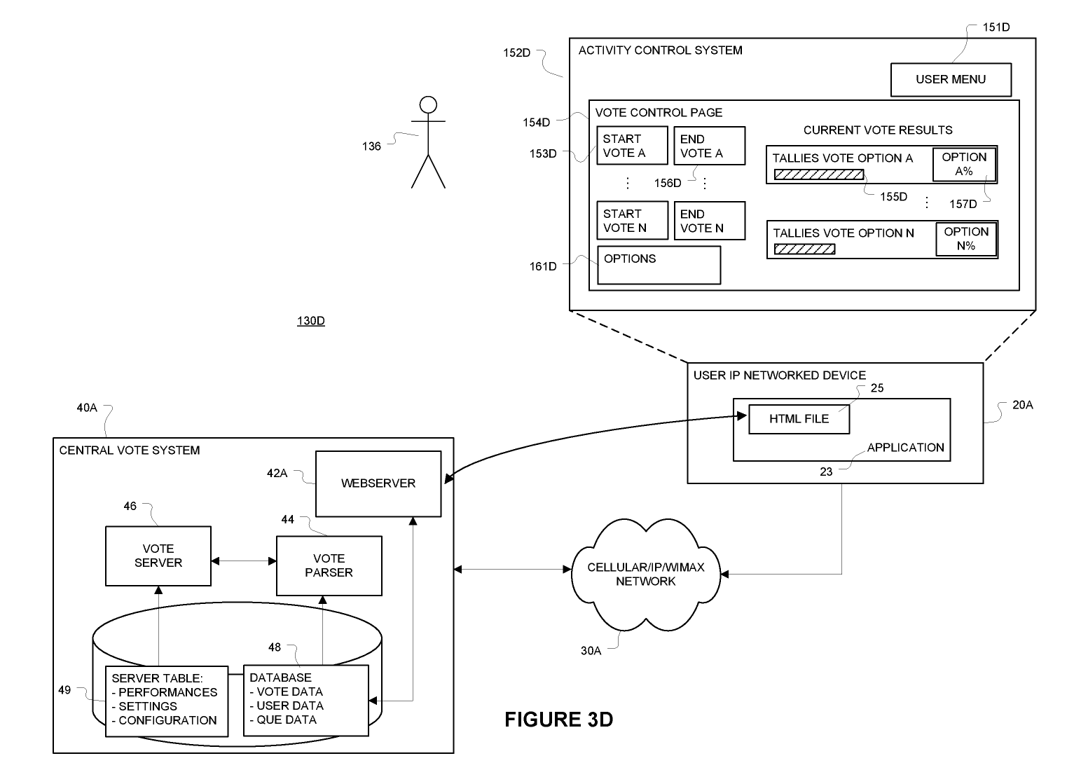

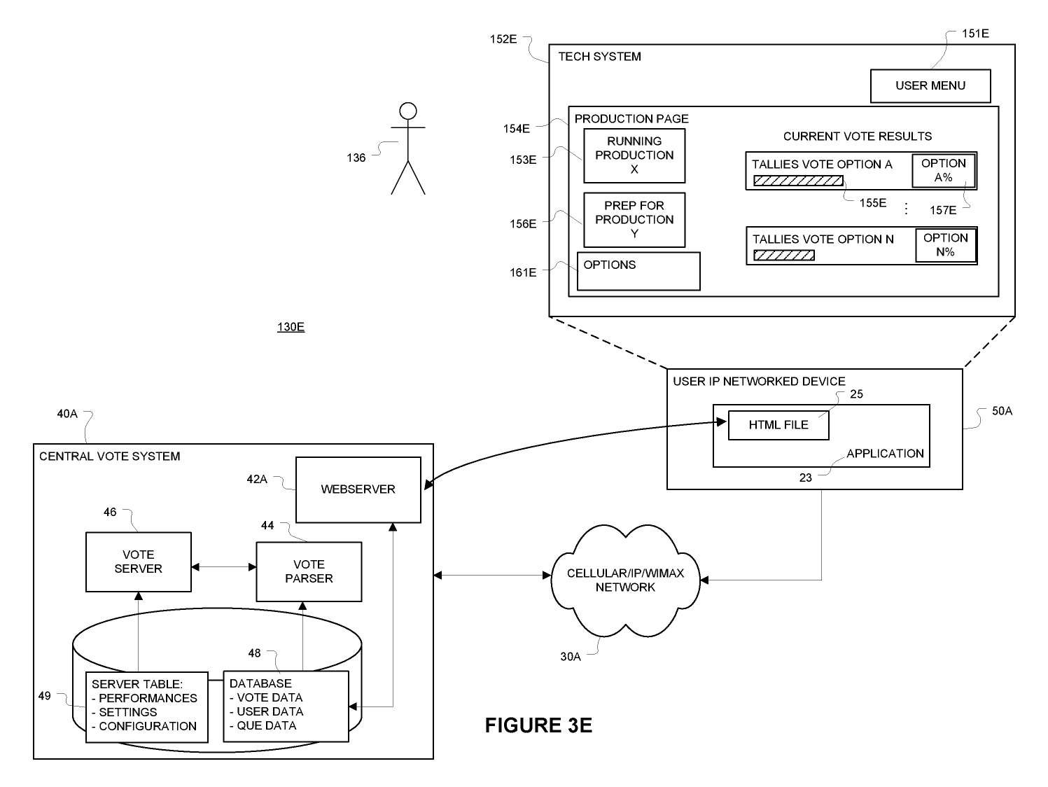

As noted, a CVA 40A may employ the methods 170A shown in FIG. 5A to communicate with User devices 10A-B according to various embodiments. When an Attendee 136 requests a performance participation page (communication 81A), activity 172A, a CVA 40A may forward a performance participation page (communication 82A) activity 174A (of FIG. 5A) as shown in FIG. 3A. FIG. 3A is a block diagram of single or multiple performance attendee participation architecture 130A providing a user or attendee performance registration page 152A to a user device 10A according to various embodiments. As shown in FIG. 3A, a CVA 40A may include a web server 42A, a vote parser 44, a vote server 46, a database 48, and a server table 49. The webserver 42A may communicate web pages between the CVA 40A and other systems 20, 50, 60, 70, and 80. The vote parser 44 may receive votes from UDs 10A-B via the webserver 42A, organize them and process them via the vote server 46 and database 48.

The database 48 may store vote data, user data, and queuing equipment data. The server table 49 may include performance code and votes, general settings, and configuration parameters. As shown in FIG. 3A, a CVS 40A may communicate a performance registration page 152A to a UD 10A in the form of a hyper-text markup language (HTML) file 15. A UD 10A-B may employ an HTML file decoder such a web browser application 13 to view the HTML file 15 and provide the performance registration page 152A on the UD 10A-B. As shown in FIG. 3A, the performance registration page 152A may include a User menu 151A, registration code entry page 154A, and options link 161A. An Attendee 136 may enter a registration code that is specific to the performance the Attendee is viewing or to view (communication 84A). The User menu 151A and options link 161A may enable an Attendee to view their tickets, seats, and performance information in an embodiment.

Once the CVA 40A verifies the performance code is valid (activity 176A), it may send a vote acknowledge page (communication 85A) (activity 178A). Once voting is started for an activity (activity X) (activity 182A), registered UD 10A, will be sent a vote page for activity X (activity 186A) (communication 92A). FIG. 3B is a block diagram of single or multiple performance attendee participation architecture 130A providing a user or attendee vote page 152B for activity X to a user device 10A according to various embodiments. As shown in FIG. 3B, an Attendee via their UD may be able to select one of N possible options in an embodiment.

Once an Attendee 136 select an option, their vote or selection may be forwarded the CVA 40A (communication 94A). A CVA 40A may update vote tallies and send an updated Attendees vote page (communication 96A) (activity 194A) (shown in FIG. 3C) if their option is received while the voting activity X has not ended (activity 188A, 192A). Once the vote is complete (activity 196A), a CVA 40A may send a final vote tallies to Attendees (communication 104A) for activity X. This process may be repeated (activities 182A to 196A) (communications 88N to 104N) until all votes for the performance are complete.

As shown in FIGS. 2A-B, a CVA 40A may also communicate with an ACS 20 to start and end votes. As noted, FIG. 5B is a flow diagram illustrating several methods a CVA 40A may employ to communicate with an ACS 20A according to various embodiments. As shown in FIGS. 2A-B and FIG. 5B, a CVA 40A may forward a performance control page 86A to a ACS 20A for each voting activity X (activity 172B). FIG. 3D is a block diagram of single or multiple performance attendee participation architecture 130D providing an activity control system (ACS) vote control page 154D to an ACS 20A according to various embodiments. As shown in FIG. 3D, a vote control page may include selectable icons 153D to start voting activities A to N and icons 156D to end voting activities A to N. As shown in FIG. 3D, the vote control page may also include vote activity tallies in different formats 155D, 157D for different activities A to N.

Once a manager starts a voting activity A to N, a communication 88A may be forwarded to the CVA 40A. The CVA 40A upon receiving the start vote activity A to N (X) (activity 174B) may send vote tallies (activity 176B) to the ACS 20A until the CVA 40A receives an end vote activity A to N communication from the ACS 20A (communication 102A). Once a vote activity A to N has ended, a CVA 40A may send results to the ACS 20A, tech system 50A (communication 108A) (activity 182C), UD 10A-10B (activity 104A), and display system 60A (communication 106A) (activity 182C).

FIG. 3E is a block diagram of single or multiple performance attendee participation architecture 130E providing a tech system production page 154E to a tech system 50A according to various embodiments. As shown in FIG. 3E in an embodiment a tech system production page 154E may include the activity A to N (X) currently running 153E or selected, an indication of the next activity Y 156E, and pending votes results for activities or options A to N 155E, 157E. It is noted in an embodiment, that multiple votes for activities may be conducted simultaneously or at least partially overlap.

As shown in FIG. 2B, a CVA 40A may also send vote tallies to the equipment queuing system 70A (communication 110A). In an embodiment, the equipment queuing system 70A may forward commands or queues to performance equipment (communications 112A to 112N) based on the vote results. In another embodiment, the CVA 20A may forward commands or queues to performance equipment based on the vote results (activity 178D of FIG. 5D).

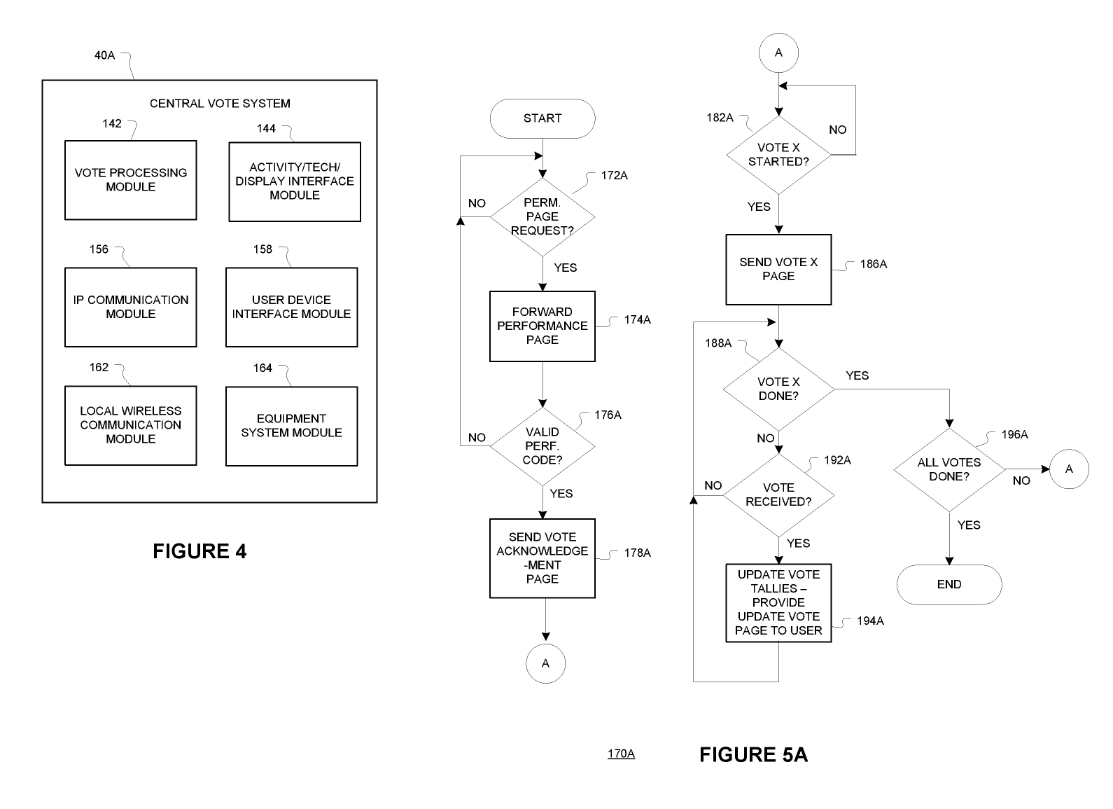

FIG. 4 is a block diagram of a central vote system (CVS) 40A according to various embodiments. As shown in FIG. 4, a CVS 40A may have a vote processing module 142, an activity, tech, and display system interface module 144, an internet protocol (IP) communication module 156, a User Device interface module 158, a local wireless communication module 162, and an equipment system module 164. The vote processing module 142 may record and tallies votes for activities A on N for a plurality of performances and store the data in the database 48.

The activity, tech, and display system interface module 144 may perform the activities of methods 170B and 170C, create the pages shown in FIGS. 3D and 3E and communications shown in FIGS. 2A and 2B as discussed. The internet protocol (IP) communication module 156 may enable wireless and wired communication between systems 20, 50, 60, 70, and 80 via a network or networks 30A, 30B. The User Device interface module 158 may perform the activities of the method 170A, create the pages shown in FIGS. 3A-3C and communications shown in FIGS. 2A and 2B as discussed. The local wireless communication module 162 may enable local wired or wireless communication with systems 20, 50, 60, 70, and 80. The equipment system module 164 may perform the activities of the method 170D and communications shown in FIG. 2B as discussed.

FIG. 6A illustrates a block diagram of a device 230 that may be employed at least in part in a CVA 40A or system 20, 50, 60, 70, 80, 90 in various embodiments. The device 230 may include a central processing unit (CPU) 232, a random access memory (RAM) 234, a read only memory (ROM) 237, a local wireless/GPS modem/transceiver 244, a display 247, a camera 256, a speaker 245, a rechargeable electrical storage element 256, and an antenna 246. The CPU 232 may include a control interface 254 including an IP type network controller interface (NIC). The RAM 234 may include a queue or table 234A where the queue 234A may be used to store votes until parsed, web pages, applications, or APIs. The RAM 234 may also include program, algorithm, and system data and instructions. The rechargeable electrical storage element may be a battery or capacitor in an embodiment.

The modem/transceiver 244 may couple, in a well-known manner, the device 230 to a wired or wireless network 30A, 30B to enable communication with other of CVA 40A or system 20, 50, 60, 70, 80, 90 and UD 10A-10B. The modem/transceiver 244 may also be able to receive global positioning signals (GPS) and the CPU 232 may be able to convert the GPS signals to location data that may be stored in the RAM 234. The ROM 237 may store program instructions to be executed by the CPU 232 or server 254 (applications 237A). The applications 237A may include a web browser program or application.

FIG. 6B illustrates a block diagram of a device 260 that may be employed at least in part in a system 20, 50, 60, 70, 80, 90 or UD 10A-10B in various embodiments. The device 260 may include a central processing unit (CPU) 262, a random access memory (RAM) 264, a read only memory (ROM) 266, a display 268, a user input device 272, a transceiver application specific integrated circuit (ASIC) 274, a microphone 288, a speaker 282, storage 276, electrical energy storage unit 286, and an antenna 284. The CPU 262 may include an interface 292. The RAM 264 may include a queue 278 where the queue 278 may webpages.

The ROM 266 is coupled to the CPU 262 and may store the program instructions to be executed by the CPU 262 and the interface 292. The RAM 264 may be coupled to the CPU 262 and may store temporary program data, overhead information, and the queues 278. The user input device 272 may comprise an input device such as a keypad, touch pad screen, track ball or other similar input device that allows the user to navigate through menus in order to operate the device 260. The display 268 may be an output device such as a CRT, LCD or other similar screen display that enables the user to read, view, or hear multimedia content.

The microphone 288 and speaker 282 may be incorporated into the device 260. The microphone 288 and speaker 282 may also be separated from the device 260. Received data may be transmitted to the CPU 262 via a serial bus 275 where the data may include messages or pages received, messages, or web pages to be transmitted, or protocol information. The transceiver ASIC 274 may include an instruction set necessary to communicate messages or web pages, applications, APIs, and data via network 30A, 30B. The ASIC 274 may be coupled to the antenna 284 to communicate messages, content, or pages wireless. When a message is received by the transceiver ASIC 274, its corresponding data may be transferred to the CPU 262 via the serial bus 276. The data can include wireless protocol, overhead information, sensor, and pages to be processed by the device 260 in accordance with the methods described herein.

The rechargeable electrical storage element 286 may be a battery or capacitor in an embodiment. The storage 276 may be any digital storage medium and may be coupled to the CPU 262 and may store temporary program data, overhead information, and databases 48, 49.

Any of the components previously described can be implemented in a number of ways, including embodiments in software. Any of the components previously described can be implemented in a number of ways, including embodiments in software. Thus, the devices 230, 260 elements including the RAM 234, ROM 237, CPU 232, transceiver 244, storage 276, CPU 262, RAM 264, ROM 266, and transceiver ASIC 274, may all be characterized as “modules” herein.

The modules may include hardware circuitry, single or multi-processor circuits, memory circuits, software program modules and objects, firmware, and combinations thereof, as desired by the architect of the architecture 10 and as appropriate for particular implementations of various embodiments.

The apparatus and systems of various embodiments may be useful in applications other than a sales architecture configuration. They are not intended to serve as a complete description of all the elements and features of apparatus and systems that might make use of the structures described herein.

Applications that may include the novel apparatus and systems of various embodiments include electronic circuitry used in high-speed computers, communication and signal processing circuitry, modems, single or multi-processor modules, single or multiple embedded processors, data switches, and application-specific modules, including multilayer, multi-chip modules. Such apparatus and systems may further be included as sub-components within a variety of electronic systems, such as televisions, cellular telephones, personal computers (e.g., laptop computers, desktop computers, handheld computers, tablet computers, etc.), workstations, radios, video players, audio players (e.g., mp3 players), vehicles, medical devices (e.g., heart monitor, blood pressure monitor, etc.) and others. Some embodiments may include a number of methods.

It may be possible to execute the activities described herein in an order other than the order described. Various activities described with respect to the methods identified herein can be executed in repetitive, serial, or parallel fashion.

A software program may be launched from a computer-readable medium in a computer-based system to execute functions defined in the software program. Various programming languages may be employed to create software programs designed to implement and perform the methods disclosed herein. The programs may be structured in an object-orientated format using an object-oriented language such as Java or C++. Alternatively, the programs may be structured in a procedure-orientated format using a procedural language, such as assembly or C. The software components may communicate using a number of mechanisms well known to those skilled in the art, such as application program interfaces or inter-process communication techniques, including remote procedure calls. The teachings of various embodiments are not limited to any particular programming language or environment.

The accompanying drawings that form a part hereof show, by way of illustration and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein individually or collectively by the term “invention” merely for convenience and without intending to voluntarily limit the scope of this application to any single invention or inventive concept, if more than one is in fact disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In the foregoing Detailed Description, various features are grouped together in a single embodiment for the purpose of streamlining the disclosure. This method of disclosure is not to be interpreted to require more features than are expressly recited in each claim. Rather, inventive subject matter may be found in less than all features of a single disclosed embodiment. Thus the following claims are hereby incorporated into the Detailed Description, with each claim standing on its own as a separate embodiment.

What is claimed is:

1. A performance viewer participation system that enables viewers to affect one or more attributes of a performance, including:
a plurality of performance viewer electronic devices (PVED), each electronic device capable of communicating one or wired or wirelessly,
a central vote system (CVS), including a server for communicating with the plurality of PVED; and
a performance system (PS) communicating with the CVS, the PS including an activity control system (ACS),
the CVS including a server that enables a User of one of the plurality of PVED to affect one or more attributes of a performance,
the PS-ACS controlling when a CVS enables a User of one of the plurality of PVED to affect one or more attributes of a performance.

2. The performance viewer participation system of claim 1, wherein the performance is live and a plurality of viewers personally attend the performance.

3. The performance viewer participation system of claim 1, wherein the CVS enables a User of one of the plurality of PVED to affect one or more attributes of a performance by voting for one or more attributes of a performance.

4. The performance viewer participation system of claim 1, wherein the CVS enables a User of one of the plurality of PVED to affect one or more attributes of a performance by voting for one or more attributes of a performance via an application installed on their PVED.

5. The performance viewer participation system of claim 4, wherein a User via one of the plurality of PVED provides a performance code to CVS in order to be able to vote for one or more attributes of a performance.

6. The performance viewer participation system of claim 4, wherein the PS-ACS controls when a CVS enables a User via one of the plurality of PVED to vote for one or more attributes of a performance.

7. The performance viewer participation system of claim 1, wherein the CVS is part of the PS.

8. The performance viewer participation system of claim 2, wherein the PS is located at the performance.

9. The performance viewer participation system of claim 8, wherein the PS provides wireless communication between the plurality of PVED and the CVS.

10. The performance viewer participation system of claim 3, wherein the CVS periodically provides live vote status to a User via one of the plurality of PVED.

11. The performance viewer participation system of claim 3, wherein the CVS periodically provides live vote status to the PS.

12. The performance viewer participation system of claim 3, wherein the PS includes a display system that displays the live vote status to one or more viewers that personally attend the performance.

13. The performance viewer participation system of claim 3, wherein the CVS provides final live vote results to a User via one of the plurality of PVED.

14. The performance viewer participation system of claim 3, wherein the CVS provides final live vote results to the PS.

15. The performance viewer participation system of claim 3, wherein the PS includes a display system that displays the final live vote results to one or more viewers that personally attend the performance.

16. The performance viewer participation system of claim 3, wherein the PS includes a tech system that displays the final live vote results to one or more performance personal that may control or affect one or more attributes of a performance.

17. The performance viewer participation system of claim 3, wherein the PS includes an equipment queuing system that controls equipment that affects one or more attributes of a performance and wherein the PS-ACS receives final live vote results and controls the operation of an equipment queuing system based on final live vote results.

18. The performance viewer participation system of claim 2, wherein the performance is live and a plurality of viewers remotely attend the performance.

19. The performance viewer participation system of claim 4, wherein the plurality of PVED are Users' personal electronic devices.

20. The performance viewer participation system of claim 19, wherein the CVS includes a webserver and provides HTML pages to the plurality of PVED.
